(19) United States
(12) Patent Application Publication
(10) Pub. No.: US 2023/0308681 A1
(43) Pub. Date: Sep. 28, 2023

(54) END-TO-END STEREO IMAGE COMPRESSION METHOD AND DEVICE BASED ON BI-DIRECTIONAL CODING

(71) Applicant: TIANJIN UNIVERSITY, Tianjin (CN)

(72) Inventors: Jianjun LEI, Tianjin (CN); Xiangrui LIU, Tianjin (CN); Bo PENG, Tianjin (CN); Dengchao JIN, Tianjin (CN); Zhaoqing PAN, Tianjin (CN); Jingxiao GU, Tianjin (CN)

(21) Appl. No.: 17/866,172

(22) Filed: Jul. 15, 2022

(30) Foreign Application Priority Data
Mar. 28, 2022 (CN) 2022103106286

(51) Int. Cl. H04N 19/577; H04N 19/597; H04N 19/42; H04N 19/60; H04N 19/13; H04N 19/124

(52) U.S. Cl. CPC H04N 19/577; H04N 19/597; H04N 19/42; H04N 19/60; H04N 19/13; H04N 19/124

(57) ABSTRACT

The present disclosure discloses an end-to-end stereo image compression method and device based on bi-directional coding, the method comprises: extracting inter-view information as prior from input left-view and right-view images by a neural network, sending the prior into left-view and right-view encoders simultaneously to jointly encode the input left-view and right-view images to generate left-view and right-view bit streams; and extracting inter-view information as the other prior from the generated left-view and right-view bit streams by the neural network, sending the other prior into left-view and right-view decoders simultaneously to jointly decode the left-view and right-view bit streams to generate reconstructed left-view and right-view images. The device comprises constructing a bi-directional coding structure for acquiring the bi-directional inter-view information and compress the stereo image based on the bi-directional inter-view information by the neural network.

### CROSS-REFERENCE TO RELATED APPLICATION

This application claims priority from the Chinese patent application 2022103106286 filed Mar. 28, 2022, the content of which is incorporated herein in the entirety by reference.

### TECHNICAL FIELD OF THE APPLICATION

The present disclosure relates to the field of image compression, particularly to an end-to-end stereo image compression method and device based on bi-directional encoding.

### BACKGROUND ART

Image compression is one of the key technologies in the field of digital image processing, aiming to minimize the bitrates required to describe images on the premise of reserving the key visual information, so as to realize efficient transmission and storage. In recent years, stereo images are widely used in the fields such as augmented reality, autonomous driving, and robot navigation. In view of this, researchers have studied stereo image compression, in which the inter-view redundancy is reduced to improve the coding efficiency. Boulgouris et al. proposed a stereo image compression method based on disparity compensation prediction. Specifically, the left image is first independently encoded, and then the reconstructed left image is specified as the reference image of the right image. When coding the right image, a prediction of the right image is generated based on the reference image using DCP, and only the estimated disparities and prediction residues are compressed. Kaaniche et al. combined a lifting wavelet scheme with the disparity compensation prediction to efficiently encode the inter-view prediction residuals. Kadaikar et al. proposed a block-based stereo image compression method to improve the accuracy of disparity compensation prediction.

With the rapid development of deep learning, end-to-end image compression based on the variational auto-encoder structure has been widely studied. An end-to-end image encoding framework usually consists of an encoder, a decoder, an entropy model and other non-learning components. The encoder maps an input image to a high-dimensional feature space through a nonlinear transform to generate a compact latent representation; the entropy model is used to estimate the probability distribution of the quantized latent representation for entropy encoding; and the decoder maps the latent representation to the color space through a nonlinear transform to generate a reconstructed image. Bane et al. proposed an end-to-end image compression method based on a convolutional neural network, in which the input image is transformed into a compact latent representation nonlinearly by a convolutional neural network. Chen et al. introduced an attention mechanism to improve the compactness of the latent representation. Ma, et al. used the lifting wavelet transform structure to realize nonlinear mapping, which alleviated the problem of information loss in the nonlinear transformation.

In recent years, researchers have made a preliminary exploration on the end-to-end stereo image compression. Liu et al. proposed a deep stereo image compression network, in which a parameterized skip function is proposed to transfer the left-view information to the right-view for the inter-view redundancy reduction. Deng et al. proposed a deep stereo image compression network based on a homography matrix. The homography matrix is used to build the corresponding relationship of left and right views, and the decoded left-view is used to predict the right-view image according to the homography matrix.

In the process of realizing the present disclosure, the inventor finds that there are at least the following shortcomings and deficiencies in the prior art:

The existing traditional stereo image compression method uses manually designed disparity compensation prediction methods to remove the inter-view redundancy, which makes it difficult to obtain accurate prediction in the scenario with a complex disparity relationship, thereby leading to the degradation of coding performance. The existing end-to-end stereo image compression methods adopt a unidirectional coding mechanism to reduce the inter-view redundancy, that is, independently encoding the left-view image, and then using the left-view information to provide an inter-view context for the right viewpoint image encoding, so as to reduce the bit consumption of the right-view image. However, the unidirectional encoding mechanism fixedly specifies view to provide the context for another view image, which cannot effectively extract the inter-view context by leveraging the information of two views, thereby making it difficult to effectively remove the inter-view redundancy.

### BRIEF SUMMARY OF THE DISCLOSURE

The present disclosure provides an end-to-end stereo image compression method and device based on bi-directional coding. According to the present disclosure, the stereo images are compressed by the deep network based on the bi-directional coding based on deep learning, thereby effectively removing inter-view redundancy of the stereo images, which is detailed below:

In a first aspect, an end-to-end stereo image compression method based on bi-directional coding, comprising:
extracting inter-view information as prior from input left-view and right-view images by a neural network, sending the prior into left-view and right-view encoders simultaneously to jointly encode the input left-view and right-view images to generate left-view and right-view bit streams; and extracting inter-view information as the other prior from the generated left-view and right-view bit streams by a neural network, sending the other prior into left-view and right-view decoders simultaneously to jointly decode the left-view and right-view bit streams to generate reconstructed left-view and right-view images.

In a second aspect, an end-to-end stereo image compression device based on bi-directional coding, comprising: constructing a bi-directional coding structure,
wherein the coding structure is configured to acquire the bi-directional inter-view information and compress the stereo image based on the bi-directional inter-view information by the neural network.

Wherein the device comprises: constructing an end-to-end compression network based on the bi-directional coding structure, the network comprising: a bi-directional contextual transform module (Bi-CTM) and a bi-directional conditional entropy model (Bi-CEM), and
constructing a bi-directional coding-based encoder and a bi-directional coding-based decoder based on the bi-directional contextual transform module; and constructing an entropy coding module with the bi-directional conditional entropy model.

In a third aspect, an end-to-end stereo image compression device based on bi-directional coding, comprising: a processor and a memory, wherein program instructions are stored in the memory, and the processor calls the program instructions stored in the memory to cause the device to perform the method steps mentioned in the first aspect.

The technical solution provided by the present disclosure has the beneficial effects that:
1. The method realizes effective compression of the stereo image by the bi-directional coding;
2. The method can learn the inter-view relationship of the stereo image, model the same as the inter-view context, and then, nonlinearly transform the stereo image conditioned on the inter-view context, thereby effectively reducing the inter-view redundancy of the stereo image;
3. The method can extract the correspondence of the left-view and right-view latent representation as the inter-view condition prior, and jointly model the probability distribution of the left-view and right-view latent representation by taking the inter-view condition prior as the condition, thereby effectively improving the probability estimate accuracy of the left and right views.

### BRIEF DESCRIPTION OF THE DRAWINGS

FIG. 1 is a flow chart of an end-to-end stereo image compression method based on bi-directional coding;

FIG. 2 is a structural schematic diagram of an end-to-end stereo image compression device based on bi-directional coding;

FIG. 3 is a structural schematic diagram of a stereo image compression network based on bi-directional coding;

FIG. 4 is a structural schematic diagram of a bi-directional contextual transform module;

FIG. 5 is a structural schematic diagram of a bi-directional conditional entropy model; and

FIG. 6 is another structural schematic diagram of an end-to-end stereo image compression device based on bi-directional coding.

### DETAILED DESCRIPTION OF THE PRESENT DISCLOSURE

In order to make objects, technical solutions and advantages of the present application clearer, the detailed description is further made below to the embodiments of the present disclosure.

### Embodiment 1

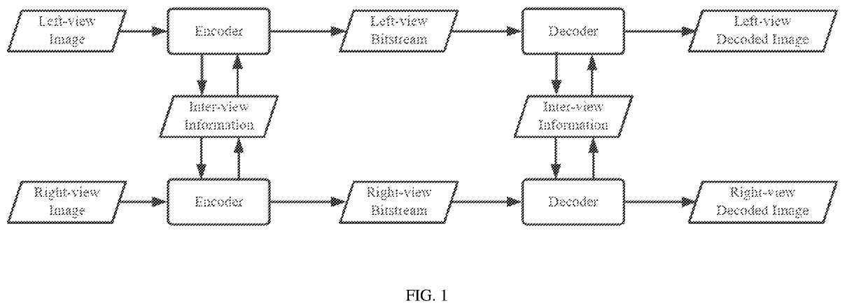

The embodiment of the present disclosure provides an end-to-end stereo image compression method based on bi-directional coding, as shown in FIG. 1, including the following steps:
101: conducting joint coding for the input left-view and right-view images by a neural network to generate left-view and right-view bit streams; Wherein the joint coding in Step 101 includes: extracting inter-view information as prior from input left-view and right-view images by a neural network, feeding the priors into the left-view and right-view encoders simultaneously to remove the inter-view redundant information of a stereo image.
102: conducting joint decoding for the generated left-view and right-view bit streams by the neural network to generate reconstructed left-view and right-view images, and at this point, the coding process ends.

Wherein the joint decoding in Step 102 includes: extracting inter-view information as the other priors from the generated left-view and right-view bit streams, and sending the other priors into left-view and right-view decoders simultaneously to restore the inter-view redundant information of the stereo image.

To sum up, the embodiment of the present disclosure realizes the end-to-end stereo image compression by the Steps 101-102, and removes inter-view redundant information of the stereo image.

### Embodiment 2

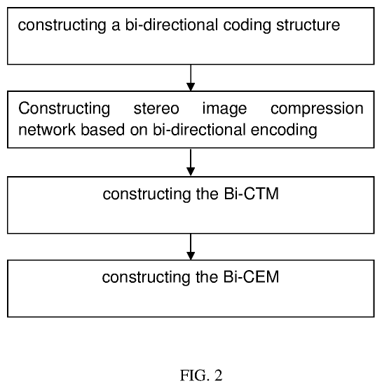

The embodiment of the present disclosure provides an end-to-end stereo image compression device based on bi-directional coding. Referring to FIG. 2, the device comprises: constructing a bi-directional coding structure;
the coding structure being configured to acquire the bi-directional inter-view information and compress the stereo images based on the bi-directional inter-view information by the neural network,
constructing an end-to-end compression network based on the bi-directional coding structure, the network comprising: a bi-directional contextual transform module and a bi-directional conditional entropy model, and
constructing a bi-directional coding-based encoder and a bi-directional coding-based decoder based on the bi-directional contextual transform module; and constructing an entropy coding module with the bi-directional conditional entropy model.

To sum up, the embodiment of the present disclosure realizes the end-to-end stereo image compression based on the bi-directional coding structure, and removes inter-view redundant information of the stereo image.

### Embodiment 3

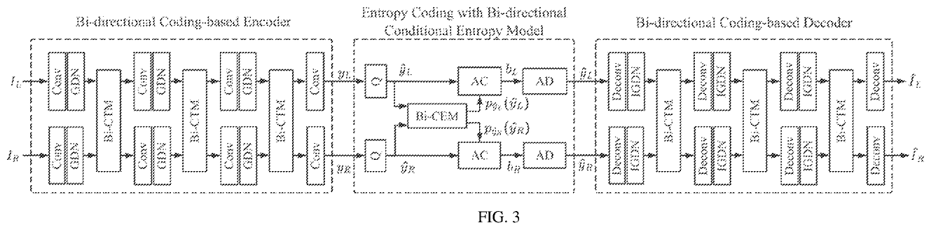

Further description is made below to the solution of Embodiment 2 in combination with FIGS. 3-5 and specific calculation formulas:

I. Building a Stereo Image Compression Network Based on Bi-Directional Coding

The structure of the built stereo image compression network based on bi-directional coding is shown as FIG. 3. The network mainly includes a bi-directional coding-based encoder, an entropy coding module with the bi-directional conditional entropy model, and a bi-directional coding-based decoder.

The bi-directional coding-based encoder consists of convolutional layers, a generalized divisor normalization (GDN) layers and bi-directional contextual transform modules, and is configured to nonlinearly transform the input stereo image {I_{R}, I_{L}} to an latent representations {y_{L}, y_{R}}. The encoder extracts left and right view features respectively using a downsampling convolutional layer and the GDN layer proposed by Bane et al., and removes inter-view redundancy using the bi-directional contextual transform module. In the encoder, the bi-directional contextual transform module is used to model the correlations between the left and right views as an inter-view context, and the left and right view features are nonlinearly transformed conditioned on the inter-view context to remove the redundancy between the left-view and right-view features. In the entropy coding module with the bi-directional conditional entropy model, quantization is firstly performed to generate the quantized latent representation {ŷ_{L}, ŷ_{R}}. Subsequently, probability distribution {p_{ŷ}_{_{L}}(ŷ_{L}), p_{ŷ}_{_{R}}(ŷ_{R})} of {ŷ_{L}, ŷ_{R}} is jointly estimated using the bi-directional conditional entropy model, and then, {ŷ_{L}, ŷ_{R}} is encoded to a binary stream {b_{L}, b_{R}} R by using an arithmetic encoder according to {p_{ŷ}_{_{L}}(ŷ_{L}), p_{ŷ}_{_{R}}(ŷ_{R})}, and the binary stream is output. In the bi-directional conditional entropy model, the correspondence of ŷ_{L} and ŷ_{R} is extracted to generate inter-view prior, and the inter-view prior is further taken as a conditional prior for the probability distribution p_{ŷ}_{_{L}}(ŷ_{L}) and p_{ŷ}_{_{R}}(ŷ_{R}) simultaneously, to improve the probability estimation accuracy.

The bi-directional coding-based decoder consists of deconvolutional layers, inverse generalized divisor normalization (IGDN) layers and the bi-directional contextual transform modules, and is configured to nonlinearly transform the decoded latent representations {ŷ_{L}, ŷ_{R}} to reconstructed images {Î_{L}, Î_{R}}. Herein, symmetrical with the bi-directional coding-based encoder, the bi-directional contextual transform module is inserted after each IGDN layer.

II. Building the Bi-Directional Contextual Transform Module

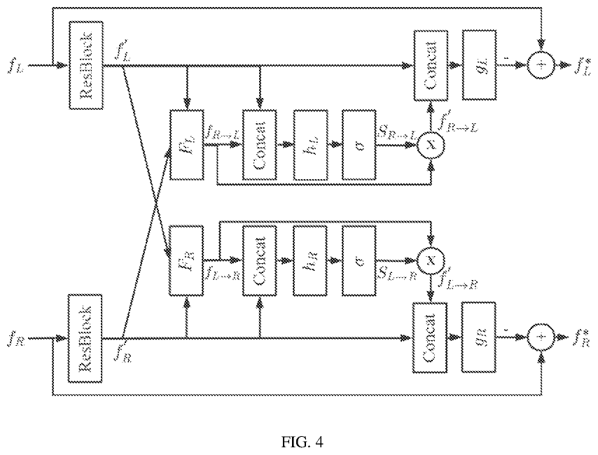

As shown in FIG. 4, the left and right features {f_{L}, f_{R}} are taken as the input of the bi-directional contextual transform module, then {f_{L}, f_{R}} are nonlinearly transformed conditioned on the inter-view context to remove the inter-view redundancy, and the transformed compact feature {f_{L}*, f_{R}*} is output. The nonlinear transformation is commonly known by those skilled in the art, and no more detailed description is made in the embodiment of the present disclosure.

Firstly, two residual blocks are used to process the left and right features {f_{L}, f_{R}} to generate representative features {f_{L}′, f_{R}′}, respectively, where f_{L}′ is the deep feature of the left view, and f_{R}′ is the deep feature of the right view. Then, two symmetrical branches are used to respectively conduct conditional nonlinear transformation for the left and right features {f_{L}, f_{R}}.

1. In the left view path, a two-stage mapping is used as to generate an inter-view context for the left features.

In the first stage, f_{R}′ is firstly mapped to the left view to generate a preliminary context f_{R→L}:

f_{R→L}=F_{L}(f_{R}′,f_{L}′) (1)

where [symbol] is a mapping function implemented by a nonlocal block proposed by Shen et al.

In the second stage, f_{R→L} is further screened by f_{L}′ to obtain a refined context f_{R→L}′:

f_{R→L}′=S_{R→L}*f_{R→L}, with S_{R→L}=σ(h_{L}(f_{R→L}⊕f_{L}′)) (2)

where S_{R→L} is an attention map for screening f_{R→L}, h_{L}(⋅) is composed of two consecutive convolution layers each having a convolution kernel size of 3*3, [symbol] is a Sigmoid function, and ⊕ is a channel-wise concatenation. Finally, f_{L} is nonlinearly transformed conditioned on the inter-view context f_{R→L}′ to generate a compact left view feature f_{L}*:

f_{L}*=f_{L}−g_{L}(f_{L}′⊕f_{R→L}′), (3)

Where g_{L}(⋅) is composed of two consecutive convolution layers each having a convolution kernel size of 3*3.

2. In the right view path, a two-stage mapping is used to generate t an inter-view context for the right features.

In the first stage, f_{L}′ is firstly mapped to the right view to generate a preliminary context f_{L→R}:

f_{L→R}=F_{R}(f_{L}′,f_{R}′), (4)

where F_{R}(⋅) is a mapping function, which is realized by a nonlocal block proposed by Shen et al.

In the second stage, f_{L→R} is further screened by f_{R}′ to obtain a refined context f_{L→R}′:

f_{L→R}′=S_{L→R}*f_{L→R}, with S_{L→R}=σ(h_{R}(f_{L→R}⊕f_{R}′)), (5)

where S_{L→R} is an attention map for screening f_{L→R}, h_{R}(⋅) consists of two-layer 3*3 convolutional layer cascade, [symbol] is a Sigmoid function, and ⊕ is a channel-wise concatenation. Finally, [symbol] is nonlinearly transformed conditioned on the inter-view context f_{L→R}′ to generate a compact left view feature f_{R}*:

f_{R}*=f_{R}−g_{R}(f_{R}′⊕f_{L→R}′), (6)

where g_{R}(⋅) is composed of two consecutive convolution layers each having a convolution kernel size of 3*3.

III. Building a Bi-Directional Entropy Encoding Model

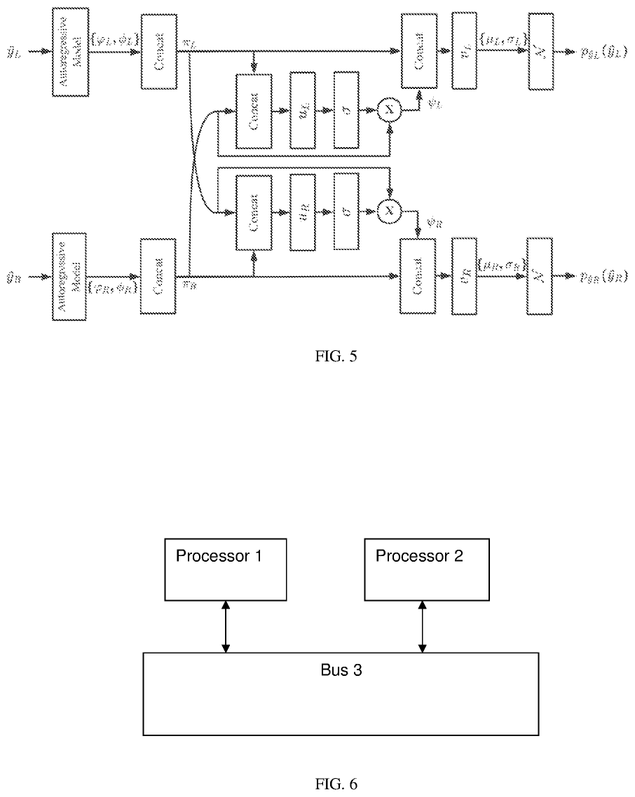

As shown in FIG. 5, the bi-directional conditional entropy model is built by taking the quantized latent representation {ŷ_{L}, ŷ_{R}} as inputs to estimate the probability distribution {p_{ŷ}_{_{L}}(ŷ_{L}), p_{ŷ}_{_{R}}(ŷ_{R})} of {ŷ_{L}, ŷ_{R}}.

Specifically, the correspondence between latent representations of the left and right views is extracted to generate inter-views prior. Inter-view prior is further utilized to provide conditional dependencies for the input latent representation and integrated into the autoregressive entropy model proposed by Minnen et al.:

$$\begin{matrix}{p}_{{\hat{y}}_{L}} ( {\hat{y}}_{L} ) = {\prod }_{i} {p}_{{\hat{y}}_{L}} ( {\hat{y}}_{L}^{i} \vert {φ}_{L} , {ϕ}_{L}^{< i} , {ψ}_{L}^{< i} ) , \\ {p}_{{\hat{y}}_{R}} ( {\hat{y}}_{R} ) = {\prod }_{j} {p}_{{\hat{y}}_{R}} ( {\hat{y}}_{R}^{j} \vert {φ}_{R} , {ϕ}_{R}^{< j} , {ψ}_{R}^{< j} ) ,\end{matrix} \qquad ( 7 )$$

where ŷ_{L}ⁱ is the i^{th} element in ŷ_{L}, ŷ_{R}^{j} is the j^{th} element in ŷ_{R}, p_{ŷ}_{_{L}} is the probability distribution of ŷ_{L}, and p_{ŷR} is the probability distribution of ŷ_{R}. The priors [symbol] are the hyperprior, the autoregressive prior, and the inter-view prior of ŷ_{L}ⁱ respectively. Similarly, the priors [symbol] are the hyperprior, the autoregressive prior, and the inter-view prior of ŷ_{R}^{j} respectively.

The hyperprior and the autoregressive prior are generated by an autoregressive entropy model proposed by Minnen, et al. according to {ŷ_{L}, ŷ_{R}}. The inter-view prior is generated according to the hyperprior and the autoregressive prior of the left and right views. Herein, the inter-view prior Ψ_{L}^{<i} of the left view is generated according to the hyperprior and the autoregressive prior of the left and right views.

Ψ_{L}^{<i}=σ(u_{L}(π_{L}^{<i}⊕π_{R}^{<i})),

with π_{L}^{<i}=φ_{L}⊕ϕ_{L}^{<i} and π_{R}^{<i}=φ_{R}⊕ϕ_{R}^{<i} (8)

where Ψ_{L}^{<i} consists of two masked convolution layers, π_{L}^{<i} the channel-wise concatenation of the left-view hyper prior and the left-view autoregressive prior corresponding to ŷ_{L}ⁱ, π_{R}^{<i} is the channel-wise concatenation of the right-view hyper prior and the right-view autoregressive prior corresponding to ŷ_{R}ⁱ.

The inter-view prior Ψ_{L}^{<i} of the right view is generated according to the hyperprior and the autoregressive prior of the left and right views.

Ψ_{R}^{<j}=σ(u_{R}(π_{R}^{<j}⊕π_{L}^{<j})),

with π_{R}^{<j}=φ_{R}⊕ϕ_{R}^{<j} and π_{L}^{<j}=φ_{L}⊕ϕ_{L}^{<j} (9)

where u_{R}(⋅) consists of two masked convolution layers, π_{R}^{<j} is the channel-wise concatenation of the right-view hyper prior and the right-view autoregressive prior corresponding to ŷ_{R}^{j}, π_{L}^{<j} is the channel-wise concatenation of the left-view hyper prior and the left-view autoregressive prior corresponding to ŷ_{L}^{j}.

In addition, a Gaussian conditional model is used to parametric model the probability {p_{ŷ}_{_{L}}(ŷ_{L}), p_{ŷ}_{_{R}}(ŷ_{R})}:

p_{ŷ}_{_{L}}(ŷ_{L}ⁱ)˜N(μ_{L}ⁱ,σ_{L}ⁱ),

p_{ŷ}_{_{R}}(ŷ_{R}^{j})˜N(μ_{R}ⁱ,σ_{R}^{j}). (10)

where μ_{L}ⁱ and σ_{L}ⁱ are respectively means and scales of the Gaussian conditional model corresponding to ŷ_{L}ⁱ, and μ_{R}ⁱ and σ_{R}^{j} are respectively means and scales of the Gaussian conditional model corresponding to ŷ_{R}^{j}.

The Gaussian model parameters are estimated by the priors:

μ_{L}ⁱ,σ_{L}ⁱ=v_{L}(φ_{L},ϕ_{L}^{<i},Ψ_{L}^{<i}),

μ_{R}^{j},σ_{R}^{j}=v_{R}(φ_{R},ϕ_{R}^{<j},Ψ_{R}^{<j}), (11)

where y_{L}(⋅) and v_{R}(⋅) are respectively Gaussian model parameter estimation functions of the left and right views, and realized by the stacked 1*1 convolution.

To sum up, the embodiment of the present disclosure realizes the end-to-end stereo image compression by the aforementioned modules, and removes the inter-view redundant information of the stereo image.

### Embodiment 4

An end-to-end stereo image compression device based on bi-directional coding, referring to FIG. 6, the device comprising: a processor and a memory, wherein program instructions are stored in the memory, and the processor calls the program instructions stored in the memory to cause the device to perform the following method steps in Embodiment 1:
extracting inter-view information for input left and right view images by a neural network, sending into left and right view encoders as prior simultaneously, and conducting joint encoding for the input left and right view images to generate left-view and right-view bit streams; and
extracting inter-view information for the generated left-view and right-view bit streams by the neural network, sending into left and right view decoders as prior simultaneously, and conducting joint decoding for the generated left-view and right-view bit streams to generate reconstructed left and right view images.

To sum up, the embodiment of the present disclosure realizes the end-to-end stereo image compression based on the device according to the present disclosure, and eliminates redundant information between the views in the stereo image.

The embodiments of the present application make special description on the models of the devices, and make no limitation to the models of other devices as long as such devices can complete the above functions.

Those skilled in the art can understand that the drawings are only the schematic diagram of a preferred embodiment, and the serial numbers of the above embodiments of the present disclosure are only for description, and do not represent the advantages and disadvantages of the embodiments.

The above contents are only better embodiments of the present disclosure, and not used to limit the present disclosure. Any modification, equivalent replacement, and improvement made within the spirit and principle of the present disclosure shall fall within the protection scope of the present disclosure.

What is claimed is:

1. An end-to-end stereo image compression method based on bi-directional coding, comprising:
extracting inter-view information as prior from input left-view and right-view images by a neural network, sending the prior into left-view and right-view encoders simultaneously to jointly encode the input left and right view images to generate left-view and right-view bit streams; and
extracting inter-view information as the other prior from the generated left-view and right-view bit streams by the neural network, sending the other prior into left-view and right-view decoders simultaneously to jointly decode the left-view and right-view bit streams to generate reconstructed left-view and right-view images.

2. An end-to-end stereo image compression device based on bi-directional coding, wherein the device comprising:
constructing a bi-directional coding structure,
wherein the encoding structure is configured to acquire the bi-directional inter-view information and compress the stereo image based on the bi-directional inter-view information by the neural network.

3. The end-to-end stereo image compression device based on bi-directional coding according to claim 2, wherein the device comprises: constructing an end-to-end encoding network based on the bi-directional coding structure, the network comprising: a bi-directional contextual transform module and a bi-directional conditional entropy model, and
constructing a bi-directional coding-based encoder and a bi-directional coding-based decoder based on the bi-directional contextual transform module; and constructing an entropy coding module with the bi-directional conditional entropy model.

4. The end-to-end stereo image compression device based on bi-directional coding according to claim 3, wherein the bi-directional contextual transform module is used for:
taking the left and right features as input, modeling the correlations between the left and right features as an inter-view context, and nonlinearly transforming the left and right features conditioned on the inter-view context to remove the redundancy between the left and right features, and outputting the transformed compact feature.

5. The end-to-end stereo image compression device based on bi-directional coding according to claim 3, wherein the bi-directional conditional entropy model is used for:
extracting correspondence between the latent representations of the left and right views to generate inter-view prior, and conducting the joint probability estimation conditioned the inter-view prior together with the hyper prior and the autoregressive prior; using a Gaussian conditional model to conduct parametric modeling for the probability.

6. The end-to-end stereo image compression device based on bi-directional coding according to claim 3, wherein the bi-directional coding-based encoder consists of convolutional layers, generalized divisor normalization layers and bi-directional contextual transform modules, and is configured to nonlinearly transform the input stereo image to compact latent representation.

7. The end-to-end stereo image compression device based on bi-directional coding according to claim 3, wherein
the entropy coding module is used for quantizing the latent representation to generate the quantized latent representation {ŷ_{L}, ŷ_{R}}, and the bi-directional conditional entropy model is used for jointly estimating the probability distribution of the quantized latent representations {ŷ_{L}, ŷ_{R}}, and the quantized latent representations {ŷ_{L}, ŷ_{R}} are encoded to bit stream by using an arithmetic encoder according to the probability distribution, and the bit stream is output as an encode results of the stereo image.

8. The end-to-end stereo image compression device based on bi-directional coding according to claim 3, wherein the bi-directional coding-based decoder consists of deconvolutional layers, inverse generalized divisor normalization layers and the bi-directional contextual transform modules, and is configured to nonlinearly transform the quantized latent representations{ŷ_{L}, ŷ_{R}} decoded by an arithmetic decoder to decoded stereo images.

9. An end-to-end stereo image compression device based on bi-directional coding, wherein the device comprising: a processor and a memory, wherein program instructions are stored in the memory, and the processor calls the program instructions stored in the memory to cause the device to perform the method steps according to claim 1.
